(19) United States
(12) Patent Application Publication
(10) Pub. No.: US 2006/0060552 A1
(43) Pub. Date: Mar. 23, 2006

(54) Disposable fluid container

(76) Inventor: Rima Kasprzak, Bay Point, CA (US)

Correspondence Address: WEST & ASSOCIATES;A PROFESSIONAL CORPORATION, 2121 NORTH CALIFORNIA BOULEVARD, SUITE 290, WALNUT CREEK, CA, 94596, US

(21) Appl. No.: 11/228,047

(22) Filed: Sep. 15, 2005

Related U.S. Application Data
(60) Provisional application No. 60/610,791, filed on Sep. 17, 2004.

(51) Int. Cl. A61J 11/00

(52) U.S. Cl. 215/11.1; 222/495; 220/703; 99/275

(57) ABSTRACT

A disposable nourishing apparatus comprises an amount of fluid, a cartridge including an opening, a delivery tip for delivering the fluid and a breakable seal forming a barrier at the opening. The delivery tip includes a tip end and a base end, wherein the base end is coupled to the cartridge. The cartridge contains the amount of fluid which comprises appropriate fluid nourishment. The breakable seal is broken by applying a force to the delivery tip thereby puncturing the breakable seal. In some embodiments, the delivery tip is permanently coupled to the cartridge. Alternatively, the delivery tip is removably coupled to the cartridge. In some embodiments, the present device further comprises an inner bladder housed within the cartridge. In other embodiments, the disposable nourishing apparatus further comprises a reinforcement component coupled to the cartridge. A disposable baby bottle is an exemplary embodiment of the disposable nourishing apparatus. In some embodiments, the fluid comprises pre-mixed baby formula.

### RELATED APPLICATION

This Patent Application claims priority under 35 U.S.C. 119 (e) of the co-pending U.S. Provisional Patent Application, Ser. No. 60/610,791 filed Sep. 17, 2004, and entitled “BUSY BABY DRINKABLES.” The Provisional Patent Application, Ser. 60/610,791 filed Sep. 17, 2004, and entitled “BUSY BABY DRINKABLES” is also hereby incorporated by reference.

### FIELD OF THE INVENTION

The present device relates to the field of nourishment bottles. More specifically, the present device relates to the field of disposable baby bottles wherein the bottle and nipple are disposable.

### BACKGROUND

In an increasingly on-the-go world, there are many products directed towards fast and convenient satisfaction of hunger and thirst. Babies too require on-the-go feeding and drinking. The conventional baby bottle and nipple assembly must be entirely washed after each use. Furthermore, the formula is bought separately and is not typically a pre-mixed fluid. Therefore, to prepare a delicious meal or snack for a baby, a parent must buy reusable bottles and nipples, separately buy formula, and mix the formula. After feeding, a parent must thoroughly wash both the nipple assembly and the bottle. The process takes precious time from the parent and often still exposes a youngster to dirty bottles and nipples. To lessen the cleaning, some products utilize bag liners. However, the nipple still requires extensive washing as well as the bottle. Further, these products do not alleviate the need to buy and mix formula. Some products suggest pre-mixed formula in a disposable baby bottle used in conjunction with a traditional nipple and ring assembly. Again, this solution still does not alleviate the need to thoroughly wash a reusable nipple after feeding.

### SUMMARY

In one embodiment of the device, a disposable nourishing apparatus comprises an amount of fluid, a cartridge including an opening, a delivery tip for delivering the fluid and a breakable seal forming a barrier at the opening. The cartridge contains the amount of fluid, which comprises appropriate fluid nourishment such as pre-mixed baby formula. The delivery tip includes a tip end and a base end, wherein the base end is coupled to the cartridge. The breakable seal is broken by applying force to the delivery tip, thereby puncturing the breakable seal. In some embodiments, the delivery tip is permanently coupled to the cartridge. The cartridge may be made from a flexible material such as foil or plastic, as well as any other known or convenient material. In some embodiments, the present device further comprises an inner bladder housed within the cartridge. In other embodiments, the disposable nourishing apparatus further comprises a reinforcement component coupled to the cartridge.

In another aspect of the present device, a disposable baby bottle comprises an amount of fluid, a cartridge including an opening, a nipple for delivering the fluid, and a breakable seal forming a barrier at the opening. The cartridge contains the amount of fluid. The nipple includes a tip end and a base end, wherein the base end is coupled to the cartridge. In some embodiments, the fluid may comprise pre-mixed baby formula or alternatively comprise other appropriate fluid nourishment. The breakable seal is broken by applying force to the delivery tip thereby puncturing the seal. In some embodiments, the cartridge is made of a flexible material such as plastic, foil, or any other known or convenient material. In some embodiments, the nipple is integrally formed to the cartridge. Alternatively, the nipple is removably coupled to the cartridge. In some embodiments, the disposable baby bottle further comprises a reinforcement component coupled to the cartridge. Some embodiments of the disposable baby bottle further comprise an inner bladder housed within the cartridge.

In yet another aspect of the present device, a disposable baby bottle comprises an amount of fluid, a cartridge including an opening, a disposable nipple for delivering the fluid, and a removable seal forming a barrier at the opening. The cartridge contains the amount of fluid. The nipple includes a tip end and a base end wherein the base end is coupled to the cartridge. The nipple is removably coupled to the cartridge and is designed for one time use.

In another aspect of the present device, a method of manufacturing a disposable nourishing apparatus comprises procuring an amount of fluid, filling a cartridge with the amount of fluid, sealing an opening of the cartridge with a breakable seal and affixing a disposable delivery tip for delivering the fluid. In some embodiments, the fluid is pre-mixed baby formula, or alternatively the fluid is nourishment appropriate to the individual who ultimately consumes the fluid. In some embodiments, the breakable seal is broken by applying force to the delivery tip, thereby puncturing the seal. In some embodiments, the disposable delivery tip is integrally formed to the cartridge. Alternatively, the disposable delivery tip is removably coupled to the cartridge. Some embodiments of the present device disclose inserting an inner liner into the cartridge before filling the cartridge with fluid.

In still another aspect of the present device, a method of opening a disposable nourishing apparatus comprises obtaining a disposable nourishing apparatus, applying a pressure to the nipple, the pressure applied in the direction of the seal and puncturing the breakable seal. The disposable nourishing apparatus above further comprises an amount of fluid, a cartridge including an opening, wherein the cartridge contains the amount of fluid, a delivery tip for delivering the fluid including a tip end and a base end, wherein the base end is coupled to the cartridge, and a breakable seal forming a barrier between the opening and the base end.

Other features and advantages of the present device will become apparent after reviewing the detailed description of the embodiments set forth below.

### BRIEF DESCRIPTION OF THE DRAWINGS

FIG. 1A illustrates a disposable infant bottle in accordance with the present device.

FIG. 1B illustrates a disposable baby bottle in accordance with the present device.

FIG. 1C illustrates a disposable toddler bottle in accordance with the present device.

FIG. 2A illustrates an exploded view of a disposable baby bottle in accordance with the present device.

FIG. 2B illustrates the breakable seal in accordance with the present device.

FIG. 2C illustrates the breakable seal in accordance with the present device and the method of breaking the breakable seal.

FIG. 2D illustrates the removable seal in accordance with the present device and the method of removing the removable seal.

FIG. 3 illustrates an embodiment of the disposable nourishing apparatus in accordance with the present device.

FIG. 4A illustrates an alternative embodiment of the disposable nourishing apparatus in accordance with the present device.

FIG. 4B illustrates a further alternative embodiment of the disposable nourishing apparatus in accordance with the present device, particularly illustrating an inner liner.

### DETAILED DESCRIPTION

Reference will now be made in detail to the embodiments of the device, examples of which are illustrated in the accompanying drawings. While the device will be described in conjunction with the alternative embodiments, it will be understood that they are not intended to limit the device to these embodiments. On the contrary, the device is intended to cover alternatives, modifications and equivalents, which may be included within the spirit and scope of the device as defined by the appended claims. Furthermore, in the following detailed description of the present device, numerous specific details are set forth in order to provide a thorough understanding of the present device. However, it should be noted that the present device may be practiced without these specific details. In other instances, well-known methods, procedures and components have not been described in detail as not to unnecessarily obscure aspects of the present device.

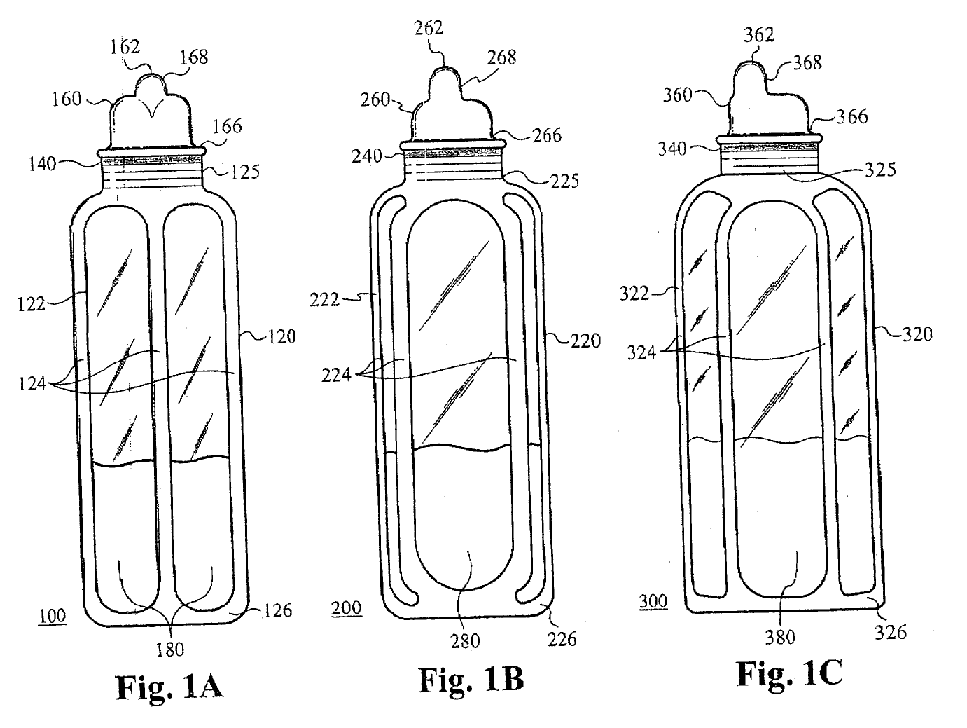

One embodiment of a disposable infant bottle 100 is illustrated in FIG. 1A. The disposable baby bottle comprises a cartridge 120, a breakable seal 140, a nipple 160 and an amount of fluid 180. The cartridge 120 holds the amount of fluid 180, and the nipple 160 is coupled to the cartridge 120. A seal 140 acts as a barrier, prevents spoiling and prevents the fluid 180 from seeping or spilling from the cartridge 120. The embodiment shown in FIG. 1A is intended for an infant. Accordingly, features of this embodiment are directed towards use by the small hands and mouths of infants.

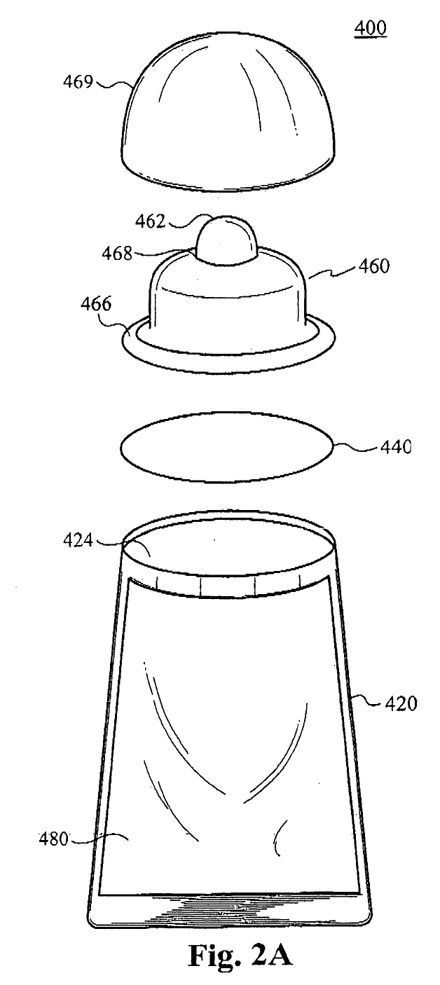

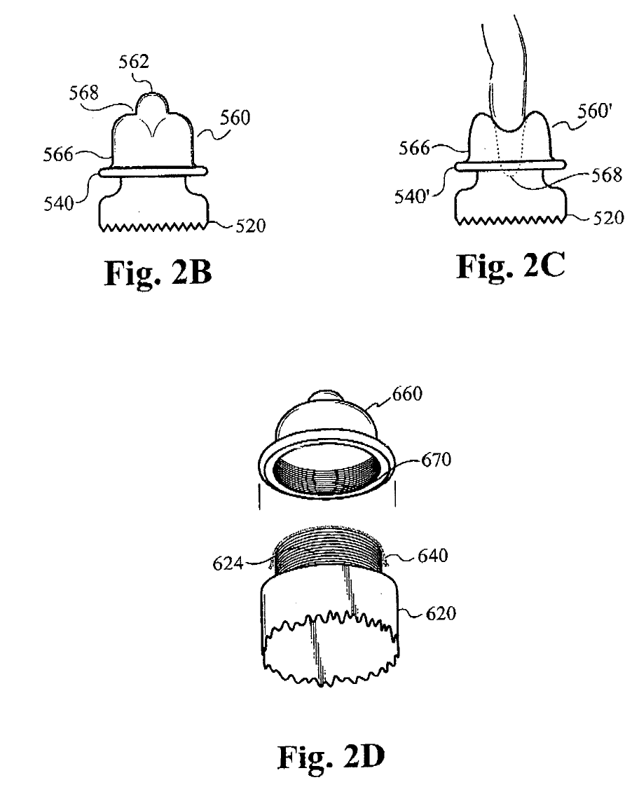

The cartridge 120 is made of an appropriate material for containing fluids that is safe and sterile. The cartridge 120 includes an opening 424 (see FIG. 2A) used to insert the fluid in the manufacturing process. In one embodiment of the present device, the cartridge 120 is flexible, such as a conventional juice box or conventional pouch drink. In other embodiments, the cartridge 120 is elongated or narrow so that the small hands of an infant are capable of grasping the disposable infant bottle 100. In one embodiment, a reinforcement component 122 is coupled to the cartridge 120. The reinforcement component 122 comprises a plurality of ribs 124, an upper ring 125 and a lower ring 126. In some embodiments, the reinforcement component 122 is made of rubber. Alternatively, the reinforcement component is made of any other known or convenient material that is safe, sterile and semi-rigid. The purpose of the reinforcement component 122 is to give the cartridge 120 added rigidity and to provide a non-slip surface. The non-slip surface facilitates handling by the infant or the infant's feeder and prevents sliding when placed on an uneven surface. The upper ring 125 encircles the top of the cartridge 120 where the cartridge 120 is coupled to the nipple 160. The upper ring 125 serves to reinforce the coupling of the nipple to the cartridge and provide a non-slip gripping point. The plurality of ribs 124 are coupled to the upper ring 125 with substantially equal distances separating each individual rib. The plurality of ribs 124 are substantially parallel to the longitudinal axis of the cartridge 120. The plurality of ribs 124 provide the cartridge 120 with structural support when the infant consumes the fluid 180. The plurality of ribs 124 meet the lower ring 126 which is coupled substantially near the bottom of the cartridge 120. The lower ring 126 encircles the bottom of the cartridge 120. It is obvious to one skilled in the art to make many variations of the reinforcement component 122 without departing from the spirit and scope of the present device.

The seal 140 is made of an appropriate material conventionally used for sealing a fluid container. In one embodiment, the seal is made of plastic. In another embodiment, the seal is made of foil. In other embodiments, the seal may be made of any other known or convenient material. In one embodiment, the seal should be strong and open cleanly, without creating debris. The seal covers the opening 424 (see FIG. 2A) of the cartridge preventing leakage and spoilation of the fluid. During the manufacturing process (discussed in detail below), the fluid 180 is poured into the cartridge 120 before the seal 140 is affixed to generate an air and fluid tight barrier. The seal is affixed using conventional means. In some embodiments the seal 140 is breakable by puncturing the seal. In this embodiment, it is particularly important to manufacture the breakable seal from a material that is breakable upon demand without generating debris since debris may contaminate the fluid and pose a health hazard. In some embodiments, the seal is removable and includes a pull tab for removing the seal. The method of breaking the seal 140 and the method of removing the seal 140 are discussed in detail below.

The shape of the nipple 160 is that of a conventional nipple used in conjunction with infant bottles and is designed to mimic the shape of a woman's anatomy. In one embodiment, the nipple 160 is made of any known or convenient material that is soft and flexible, yet durable enough to withstand at least one use since the nipple 160 is designed to be disposable. Acceptable nipple materials include latex, silicone, rubber, or any other known or convenient material. In one embodiment, the nipple 160 is cheap to manufacture, yet safe and acceptable to the infant. The price of traditional reusable nipples on the market currently makes it prohibitively expensive to use the nipple one time and then discard it. The nipple 160 of the present device may be manufactured at a price in which one-time use is feasible. First, the nipple 160 does not require the same level of durability as a multiple-use nipple. Multiple-use nipples must be durable enough to withstand many uses and washings in order to prevent the widening of the nipple hole and to prevent a choking hazard. This added durability requirement is not needed for the nipple 160 of the present device. Second, the nipple 160 is made with cheaper materials. Given the one-time use nature of the present device, it is not necessary that the nipple 160 be made from the softest or most flexible material on the market. Since the nipple 160 of the present device may be a one-time use nipple, the costs of manufacturing the nipples can be less.

The tip end 168 of the nipple 160 is substantially near the center of the nipple. The tip end 168 includes a nipple hole 162 which the fluid passes through for feeding. In one embodiment, the nipple hole 162 is small and similar to the size of holes contained on conventional nipples. Alternatively, the tip end 168 includes more than one nipple hole. The base end 166 is coupled to the opening 424 (see FIG. 2A) of the cartridge. The seal 140 acts as a barrier between the nipple 160 and the cartridge 120 and prevents the fluid from leaking into the nipple 160. After the seal 140 is broken or removed, the fluid is capable of flowing to the nipple 160 and out of the nipple hole 162. In some embodiments, the nipple 160 is permanently coupled to the cartridge 120. The seal 140 is broken by pressing the nipple 160 into itself thereby applying pressure to and puncturing the seal 140. In other embodiments, the nipple 160 is removable (see FIG. 2D). The fluid 180 flows through the nipple after removing the nipple 160, peeling off or puncturing the seal 140 and then reattaching the nipple 160.

The amount of fluid 180 within the bottle 100 of FIG. 1A comprises nourishment conventionally appropriate for an infant. In some embodiments, the nourishment is non-perishable. This allows the disposable baby bottle 100 complete mobility since refrigeration is not required. Alternatively, the nourishment requires refrigeration. The nourishment comprises a variety of substances including but not limited to: infant formula, electrolyte juice and purified water. In some embodiments, the fluid 180 comprises pre-mixed baby formula. Alternatively, the fluid 180 comprises an appropriate form of nourishment for an infant. The amount of fluid 180 contained within the cartridge 120 is related to factors particular to a given infant such as the size, age and/or appetite of the infant. In some embodiments, the amount of fluid may be any amount conventionally given to an infant.

In accordance with the present device, FIG. 1B illustrates an alternative embodiment of the disposable baby bottle. The disposable baby bottle 200 of FIG. 1B comprises a cartridge 220, a seal 240, a nipple 260 and an amount of fluid 280. The cartridge 220 holds the amount of fluid 280, and the nipple 260 is coupled to the cartridge 220. A seal 240 acts as a barrier, prevents spoiling and prevents the amount of fluid 280 from seeping or spilling from the cartridge 220. The embodiment shown in FIG. 1B is intended for a “baby” (in the transition period between an infant and a toddler). Accordingly, features of this embodiment are directed towards use by the relatively medium sized hands and mouth of a “baby.”

The cartridge of the embodiment shown in FIG. 1B is similar to the embodiment illustrated in FIG. 1A. In some embodiments, the cartridge 220 is of a size and a shape to enable a baby to easily grasp the disposable baby bottle 200. The amount of fluid 280 contained within the cartridge 220 is related to factors particular to a given baby such as the size, age and/or appetite of the baby. The amount of fluid may be any amount conventionally given to a baby. In some embodiments, the fluid comprises various substances including but not limited to: pre-mixed baby formula, fruit juices, whole milk, soy milk or water. Alternatively, the fluid comprises any fluid nourishment conventionally given to a baby.

In some embodiments, a reinforcement component 222 is coupled to the cartridge 220. The reinforcement component 222 comprises a plurality of ribs 224, an upper ring 225 and a lower ring 226. The reinforcement component 222 is similar to the reinforcement component 122 in FIG. 1A.

The seal 240 is similar to the seal 140 described in FIG. 1A. The opening 424 (see FIG. 2A) is covered by the seal. The seal 240 prevents spoilation and leakage of the fluid. In some embodiments; the seal 240 is breakable by puncturing. In other embodiments, the seal includes a pull tab or any other known or convenient means for removing the seal.

The nipple 260, including a tip end 268 and a base end 266, is similar to the nipple 160 described in FIG. 1A. A distinction is that the nipple 260 is directed to use with a baby (more developed than an infant). Since the baby is transitioning from the mother to an anatomically correct nipple to the next stage in development, the nipple 260 is a hybrid shape between the anatomically correct nipple and the conventional “Sippy” cup. The “Sippy” cup has a nipple-like fluid delivery tip located substantially near the circumference of the base. In this embodiment, the tip end 268 of the nipple 260 is substantially off the center of the nipple base 266. The tip end 268 includes a nipple hole 262 which the fluid passes through. In one embodiment, the nipple hole 262 is sized according to the age of the baby. Alternatively, the tip end 268 includes more than one nipple hole according to the age, size and/or appetite of the baby.

In accordance with the present device, FIG. 1C illustrates an alternative embodiment. The disposable toddler bottle 300 of FIG. 1C comprises a cartridge 320, a seal 340, a nipple 360 and an amount of fluid 380. The cartridge 320 holds the amount of fluid 380, and the nipple 360 is coupled to the cartridge 320. A seal 340 acts as a barrier, prevents spoiling and prevents the amount of fluid 380 from seeping or spilling from the cartridge 320. The embodiment shown in FIG. 1B is intended for a toddler. Accordingly, features of this embodiment are directed towards use by the hands and mouths of a toddler.

The cartridge of the embodiment shown in FIG. 1C is similar to the embodiments illustrated in FIGS. 1A and 1B. In some embodiments, the cartridge 320 is of a size and a shape to enable a toddler to easily grasp the disposable toddler bottle 300. The amount of fluid 380 contained within the cartridge 320 is related to factors particular to a given toddler such as the size, age and/or appetite of the toddler and may be any amount conventionally given to a toddler. In some embodiments, the fluid comprises various substances including but not limited to: pre-mixed toddler formula, fruit juices, whole milk, soy milk, chocolate milk or water. Alternatively, the fluid comprises any fluid nourishment conventionally given to a toddler.

In some embodiments, a reinforcement component 322 is coupled to the cartridge 320. The reinforcement component 322 comprises a plurality of ribs 324, an upper ring 325 and a lower ring 326. The reinforcement component 322 is substantially similar to the reinforcement components 122 and 222 illustrated in FIGS. 1A and 1B, respectively.

The seal 340 is similar to the seals 140 and 240 illustrated in FIGS. 1A and 1B, respectively. The opening 424 (see FIG. 2A) is covered by the seal. The seal 340 prevents spoilation and leakage of the fluid. In some embodiments, the seal 340 is breakable by puncturing. Alternatively, the seal includes a pull tab or any other known or convenient means for removing the seal.

The nipple 360 including a tip end 368 and a base end 366 is similar to the nipple 260 described in FIG. 1B. The major distinction is that the nipple 360 is directed to use with a toddler. Since the toddler is getting older, the tip end 368 of the nipple 360 is substantially near the circumference of the nipple base 366. The tip end 368 includes a nipple hole 362 which the fluid passes through. In one embodiment, the nipple hole 362 is sized according to the age of the toddler. Alternatively, the tip end 368 includes more than one nipple hole according to the age of the toddler.

It should be noted that the device discloses alternatives, modifications and equivalents, beyond the realm of baby bottles, which are within the spirit and scope of the device. The present device discloses a disposable nourishing apparatus in the general sense. The disposable nourishing apparatus comprises an amount of fluid, a cartridge including an opening, wherein the cartridge contains the amount of fluid, a delivery tip for delivering the fluid including a tip end and a base end, wherein the base end is coupled to the cartridge, and a breakable seal forming a barrier between the opening and the base end. The disposable nourishing apparatus is similar in concept to the disposable bottles directed towards young children above. The differences being obvious changes such as: different fluid contents, different sizes, different delivery tips and different cartridge shapes. It is understood that the scope of the present device covers such alternatives.

In accordance with the present device, FIG. 2A illustrates an exploded view of an embodiment of the disposable bottle 400. The nipple 460 including a nipple tip 468, nipple hole 462 and a nipple base 466 is configured to couple to the cartridge 420. In some embodiments, the nipple 460 is permanently coupled to the cartridge 420. The seal 440 is configured to couple to the cartridge 420 forming a barrier between the cartridge 420 and the nipple 460. In some embodiments a safety cap 469 is removably coupled to the nipple 460. In some embodiments the disposable bottle 400 is sealed in a sterile environment with a protective wrapper. In other embodiments, the nipple 460 is sealed in a sterile environment with a protective wrapper.

In accordance with the present device, FIGS. 2B and 2C illustrate a method of breaking the seal 540. As described, the nipple 560 includes a tip end 568 with a nipple hole 562 and a base end 566. The nipple 560 is coupled to the cartridge 520 at the base end 566. A breakable seal 540 is coupled to the cartridge 520 preventing spoilation and leakage of the fluid. In this embodiment, the nipple 560 is permanently coupled to the cartridge 520 and the seal is internal to the nipple 560 and the cartridge 520. The breakable seal 540 is broken by applying pressure to the nipple 560 towards the breakable seal 540. Now referring to FIG. 2C, the nipple will invert into itself, and the inverted nipple 560′ punctures the breakable seal. The breakable seal 540′ is punctured without any direct manipulation of the seal. That is, the user's finger never comes into contact with the breakable seal 540 since the breakable seal 540 is sealed between the nipple 560 and the cartridge 520. Once the breakable seal 540′ is punctured, the nipple rebounds back into the non-inverted position, and the disposable bottle is ready for consumption.

In accordance with the present device, FIG. 2D illustrates a method of removing a removable seal 640. The disposable nipple 660 is coupled to the cartridge 620. A removable seal 640 is coupled to the cartridge 620 preventing spoilation and leakage of the fluid. In this embodiment, the disposable nipple 660 is removably coupled to the 620 cartridge. In some embodiments, the disposable nipple 660 is removably coupled to the cartridge 620 with a coordinated set of the threads on the removable nipple and the cartridge, 670 and 624, respectively. Alternatively, the disposable nipple is removably coupled to the cartridge via a snap fit. In another alternative embodiment, the disposable nipple comprises a nipple component and a ring component similar to a conventional reusable nipple. The method of removing the removable seal comprises separating the nipple from the cartridge, then pealing or otherwise removing the seal via direct contact with the seal.

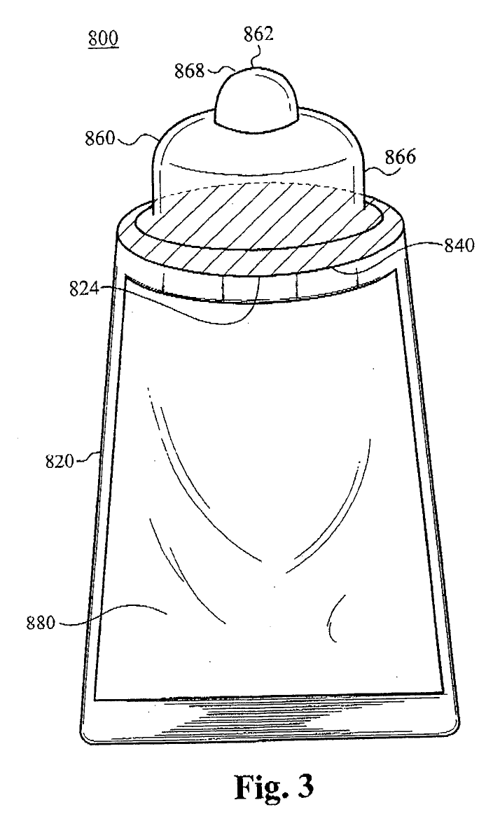

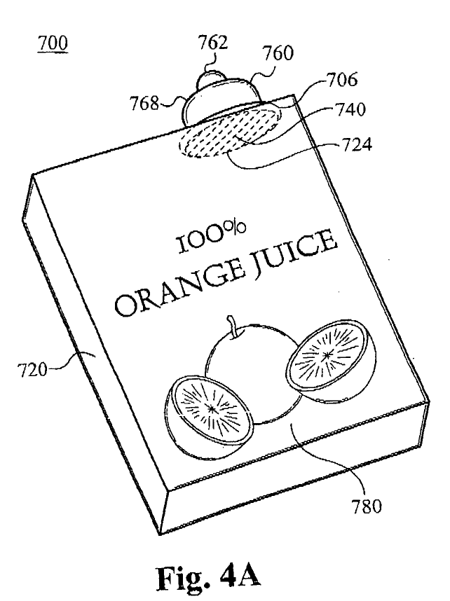

In accordance with the present device, FIG. 3 illustrates another embodiment of the present device. The disposable nourishing apparatus 800 illustrated in FIG. 3 comprises an amount of fluid 880, a cartridge 820, a delivery tip 860, and a breakable seal 840. The delivery tip 860 further comprises a tip end 868 including a delivery tip hole 862 and a base end 866. The cartridge 820 includes an opening 824 used to insert the fluid 880 during the manufacturing process, in contrast to conventional juice pouches, which require an easily lost straw and an often-littered straw wrapper. It is obvious to those skilled in the art that the cartridge can embody any number of different shapes.

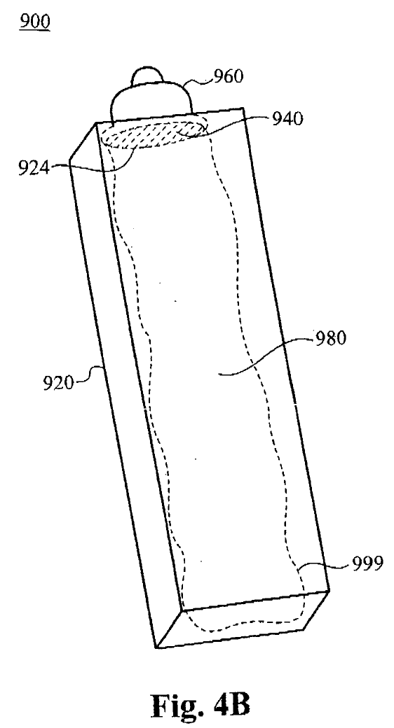

The present device discloses many alternative embodiments. In accordance with the present device, FIG. 4A illustrates an alternative embodiment of the present device. The disposable nourishing apparatus 700 comprises an amount of fluid 780, a cartridge 720, a delivery tip 760, and a breakable seal 740.

The cartridge 720 is made of an appropriate material for containing fluids that is safe and sterile. The cartridge 720 includes an opening 724 used to insert the fluid in the manufacturing process. The cartridge 720 in the embodiment illustrated in FIG. 3A is similar to a conventional juice box. However, in contrast to the present device, the conventional juice box requires an easily lost straw and an often-littered straw wrapper. One can make modifications to the shape of the cartridge without departing from the scope of the present device.

The breakable seal 740 is similar to the seals discussed above and is made of an appropriate material conventionally used for sealing a fluid container. In one embodiment, the seal is strong and opens cleanly, without generating debris. The breakable seal 740 covers the opening 724 of the cartridge 720 preventing leakage and spoilation of the fluid. In some embodiments, the seal is breakable. The breakable seal 740 is broken by puncturing as described above and illustrated in FIGS. 2B and 2C.

In one embodiment, the delivery tip 760 is made of a material that is soft and flexible, yet durable enough to withstand at least one use, since the delivery tip 760 is designed to be disposable. Acceptable materials include latex, silicone, rubber, or any other known or convenient material, as discussed above. Alternatively, the delivery tips are a harder material such as plastic. In some embodiments, the plastic delivery tip includes a mechanism for puncturing the breakable seal without removing the delivery tip.

The tip end 768, including a hole 762, through which the fluid passes for feeding, is substantially near the center of the delivery tip 760. The base end 766 is coupled to the opening 724 of the cartridge 720. The breakable seal 740 acts as a barrier between the delivery tip 760 and the cartridge 720 and prevents the fluid from leaking. After the breakable seal 740 is broken, the fluid is capable of flowing to the delivery tip 760 and out of the delivery tip hole 762. In some embodiments, the delivery tip 760 is permanently coupled to the cartridge 720. The seal 740 is broken by pressing the delivery tip 760 into itself thereby applying pressure to and puncturing the breakable seal 740.

The amount of fluid 780 comprises conventional forms of nourishment. In some embodiments, the nourishment is non-perishable. This allows the disposable nourishing apparatus complete mobility since refrigeration is not required. Alternatively, the fluid requires refrigeration. The nourishment comprises a variety of substances including but not limited to: infant formula, baby formula, toddler formula, electrolyte juice, purified water, nutritional shakes, and conventional adult beverages. The amount of fluid 780 contained within the cartridge 720 is any amount conventionally packaged in a disposable drink.

In accordance with the present device, FIG. 4B illustrates another alternative embodiment of the present device. The disposable nourishing apparatus 900 comprises a delivery tip 960, a cartridge 920 including an opening 924, a breakable seal 940, an amount of fluid 980 contained within an inner liner 999. The inner liner 999 is a bladder, which contains the fluid 980 within the cartridge 920. In some embodiments, the inner liner 999 is a flexible plastic. As the fluid 980 is consumed, the inner liner 999 compresses proportionally to the amount of fluid consumed. The cartridge 920 is rigid yet made of a safe material so that the cartridge 920 retains its shape as the fluid 980 is consumed. Since the inner liner 999 flattens within the cartridge 920 and the cartridge 920 retains its shape as the fluid 980 is consumed, the disposable nourishing apparatus 900 retains the ability to stand upright while preventing excess air from entering the inner liner 999. A major advantage of this embodiment of the present device is that preventing excess air in the inner liner 999 lessens incidents of painful gas in infants, babies, and toddlers.

The present device discloses a method of manufacturing a disposable nourishing apparatus. The method comprises procuring an amount of fluid, filling a cartridge with the amount of fluid, sealing an opening of the cartridge with a breakable seal and affixing a disposable delivery tip for delivering the fluid. The breakable seal is broken by applying force to the delivery tip and puncturing the seal (see FIGS. 2B and 2C). In some embodiments, the delivery tip inverts into itself to break the seal. Alternatively, the delivery tip includes a mechanism for breaking the seal. In some embodiments, the method further comprises wrapping the disposable nourishing apparatus in a wrapper. In one embodiment, the wrapper maintains a clean and sterile environment around the disposable nourishing apparatus. Other embodiments include removably coupling a safety cap to the delivery tip.

In some embodiments, the method further comprises inserting an inner liner into the cartridge before filling the cartridge/inner liner with the fluid. In one embodiment, he inner liner is a flexible plastic or any other known or convenient material suitable for containing fluids. In some embodiments, the fluid comprises a pre-mixed fluid formula. Alternatively, the fluid comprises an appropriate nourishment for children and adults of all ages. In some embodiments, the disposable delivery tip is integrally formed to the cartridge. In other embodiments, the disposable delivery tip is removably coupled to the cartridge. In yet other embodiments, the disposable delivery tip is permanently coupled to the cartridge.

The present device has many advantages over currently available disposable baby bottles. The entire baby bottle assembly is disposable. The present device discloses that the nipple is disposable as well as the cartridge. The disposable nipple allows for a sterile contact point in which a baby places his or her mouth. Cleaning the conventional reusable nipple is difficult and often not done correctly. This leads to baby illnesses. The disposable nipple alleviates this problem. The present device has other advantages relating to sterility. In some embodiments, for example, a protective wrapper or a safety cap 469 (see FIG. 2A) prevents contamination before use. After the safety cap 469 is removed, the method of breaking the breakable seal allows the puncturing of the breakable seal without exposing the fluid to polluted air through a wide hole in the cartridge before the nipple assembly is attached or reattached. The present device reduces the likelihood of contamination by dust and other airborne contaminants. A further advantage relates to hazards associated with reusable nipples. Reusable nipples become worn when not replaced at the appropriate time. However, it is difficult to determine exactly when portions of the nipple will begin to break off creating a choking hazard. With a disposable nipple, the guesswork is removed and frequency of replacement errs in favor of safety since the nipple is disposed of with each disposable baby bottle. Also, the hole of the nipple will not become over enlarged causing the infant, baby or child to consume the nourishment too quickly. This reduces incidents such as vomiting. In some embodiments, the nipple is a single formed assembly as opposed to the conventional ring and nipple. This embodiment has the advantages of lowering the cost of production and chances of nipple component loss or malfunction.

The method of breaking the breakable seal in the present device is a major improvement over presently-available bottles. In some embodiments (see FIGS. 2B and 2C), the disposable baby bottle is opened by pressing a finger into the nipple thereby applying a pressure to the seal and puncturing it. This allows the breakable seal 540 to be broken, allowing the fluid to flow, without removing a cap or nipple assembly 560 first. This allows the fluid to flow without attaching a cap or nipple 560 assembly after the seal 540′ has been broken. The nipple or delivery tip 560 is permanently coupled to the cartridge 520 in this embodiment. The breakable seal 540, which is internal to the nipple 560 and cartridge 520, is breakable without removing the nipple 560 from the cartridge 520.

The present device has many advantages over present disposable juice boxes and pouches. Conventional juice boxes and pouches have a straw loosely glued to the pouch. The straw is the means for puncturing and consuming the beverage. The present device does not require a straw that is easily lost and/or littered after use. The nipple or delivery tip of the present device is securely coupled to the cartridge. There is no risk of losing the means for puncturing and consuming the fluid since the nipple or delivery tip is securely coupled, as opposed to loosely glued. In some embodiments the breakable seal is broken by inverting the nipple with a finger and puncturing the breakable seal (see FIGS. 2B and 2C). In other embodiments, the seal is pealed off or otherwise removed and the nipple reattached (see FIG. 2C). Further, since the seal is internal to the nipple and the cartridge, the risk of accidental puncture of the seal is greatly reduced in the present device. In some embodiments, there is an inner liner 999 (see FIG. 3C). Conventional juice boxes and pouches do not include such an inner liner. The inner liner has the advantage of allowing the cartridge to have a more rigid structure and preventing a baby from ingesting excess amounts of air. Reduction of excess air ingestion reduces incidences of painful gas in infants, babies and toddlers.

The present device has been described in terms of specific embodiments incorporating details to facilitate the understanding of the principles of construction and operation of the device. Such reference herein to specific embodiments and details thereof is not intended to limit the scope of the claims appended hereto. It will be apparent to those skilled in the art that modifications may be made in the embodiment chosen for illustration without departing from the spirit and scope of the device.

What is claimed is:

1. A disposable nourishing apparatus, comprising:
a. a cartridge including an opening, wherein the cartridge contains an amount of fluid;
b. a delivery tip for delivering the fluid including a tip end and a base end, wherein the base end is coupled to the cartridge; and
c. a breakable seal forming a barrier between the opening and the base end.

2. The disposable nourishing apparatus of claim 1 wherein the breakable seal is broken by applying force to the delivery tip thereby puncturing the breakable seal.

3. The disposable nourishing apparatus of claim 1 where in the delivery tip is permanently coupled with the cartridge.

4. The disposable nourishing apparatus of claim 1 wherein the cartridge is flexible.

5. The disposable nourishing apparatus of claim 1 wherein the cartridge comprises a food-safe packaging material.

6. The disposable nourishing apparatus of claim 5 wherein the packaging material is comprised of at least one of the following: a plastic, a foil.

7. The disposable nourishing apparatus of claim 1 further comprising an inner bladder housed within the cartridge.

8. The disposable nourishing apparatus of claim 1 further comprising a reinforcement component coupled to the cartridge.

9. The disposable nourishing apparatus of claim 14 further comprising a safety cap removably coupled with the delivery tip.

10. The disposable baby bottle of claim 1 wherein fluid is a pre-mixed baby formula.

11. A disposable baby bottle, comprising:
a. a cartridge including an opening, wherein the cartridge contains an amount of fluid;
b. a nipple for delivering the fluid including a tip end and a base end, wherein the base end is coupled to the cartridge; and
c. a breakable seal forming a barrier between the opening and the base end.

12. The disposable baby bottle of claim 11 wherein the seal is broken by applying force to the delivery tip thereby puncturing the seal.

13. The disposable baby bottle of claim 11 wherein the cartridge is flexible.

14. The disposable baby bottle of claim 11 wherein the nipple is integrally formed to the cartridge.

15. The disposable baby bottle of claim 11 wherein the nipple is removably coupled with the cartridge.

16. The disposable nourishing apparatus of claim 11 wherein the cartridge comprises a food-safe packaging material.

17. The disposable nourishing apparatus of claim 16 wherein the packaging material is comprised of at least one of the following: a plastic, a foil.

18. The disposable baby bottle of claim 11 further comprising a reinforcement component coupled to the cartridge.

19. The disposable baby bottle of claim 11 further comprising a safety cap removably coupled to the delivery tip.

20. The disposable baby bottle of claim 11 further comprising an inner bladder housed within the cartridge.

21. The disposable baby bottle of claim 11 wherein fluid is a pre-mixed baby formula.

22. A disposable baby bottle, comprising:
a. a cartridge including an opening, wherein the cartridge contains an amount of fluid;
b. a disposable nipple for delivering the fluid including a tip end and a base end, wherein the base end is coupled to the cartridge; and
c. a removable seal forming a barrier between the opening and the base end.

23. The disposable baby bottle of claim 22 wherein the nipple is removably coupled with the cartridge.

24. The disposable baby bottle of claim 22 wherein the nipple is designed for one time use.

25. A method of manufacturing a disposable nourishing apparatus, comprising:
a. filling a cartridge with an amount of fluid;
b. sealing an opening of the cartridge with a breakable seal;
c. affixing a disposable delivery tip for delivering the fluid after the breakable seal is broken.

26. The method of claim 25 wherein the breakable seal is broken by applying force to the delivery tip thereby puncturing the seal.

27. The method of claim 25 further comprising sealing the disposable nourishing apparatus in a wrapper.

28. The method of claim 25 further comprising inserting an inner liner into the cartridge before filling the cartridge with fluid.

29. The method of claim 25 wherein the fluid comprises pre-mixed fluid baby formula.

30. The method of claim 25 wherein the disposable delivery tip is integrally formed to the cartridge.

31. A method of opening a disposable nourishing apparatus, comprising:
a. obtaining a disposable nourishing apparatus, comprising:
i. a cartridge including an opening, wherein the cartridge contains an amount of fluid;
ii. a delivery tip for delivering the fluid including a tip end and a base end, wherein the base end is coupled to the cartridge; and
iii. a breakable seal forming a barrier between the opening and the base end.
b. applying pressure to the nipple, the pressure applied in the direction of the seal; and
c. puncturing the breakable seal.
